(19) United States
(12) Patent Application Publication
(10) Pub. No.: US 2023/0004954 A1
(43) Pub. Date: Jan. 5, 2023

(54) VIRTUAL WALLET GENERATION

(71) Applicant: Hint, Inc., Pleasanton, CA (US)

(72) Inventors: Muthanna Nischal Ammatanda, Fremont, CA (US); Sudha Chinnappa, San Ramon, CA (US); Davis Mariotti, Concord, CA (US); Roman Tsymbalenko, Kharkiv (UA); Shrankhla Narya, San Francisco, CA (US); Bradley Beesley, Los Gatos, CA (US)

(21) Appl. No.: 17/714,559

(22) Filed: Apr. 6, 2022

Related U.S. Application Data
(60) Provisional application No. 63/217,092, filed on Jun. 30, 2021.

(51) Int. Cl. G06Q 20/36; G06Q 20/10

(52) U.S. Cl. CPC G06Q 20/3672; G06Q 20/108

(57) ABSTRACT

Systems and methods herein describe a digital wallet system. The digital wallet system identifies a first request to initiate a first transaction, receives first sensitive data corresponding to the first transaction, initiates a digital wallet based on the first sensitive data, the initiating comprising generating a first wallet item designated for completing the first transaction, stores the first wallet item in association with the generated digital wallet, and stores the digital wallet.

### CLAIM OF PRIORITY

This application claims the benefit of priority to U.S. Provisional Application Ser. No. 63/217,092 filed Jun. 30, 2021, which is incorporated herein by reference in its entirety.

### TECHNICAL FIELD

Embodiments herein generally relate to transactions for a subscription system. More specifically, but not by way of limitation, embodiments herein describe generating a digital wallet for storing financial data.

### BACKGROUND

A digital wallet allows parties to process electronic transaction by exchanging digital currency for goods and services.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example point of sale system for conducting transactions over a network.

FIG. 2 is a block diagram of a digital wallet server, according to some example embodiments.

FIG. 3 is a method for generating a digital wallet, according to example embodiments.

FIG. 4 is an illustration of a graphical user interface presented by the digital wallet server, according to example embodiments.

FIG. 5 is an illustration of a graphical user interface presented by the digital wallet server, according to example embodiments.

FIG. 6 is a block diagram illustrating a software architecture, which can be installed on any one or more of the devices described herein.

FIG. 7 is a diagrammatic representation of the machine within which instructions (e.g., software, a program, an application, an applet, an app, or other executable code) for causing the machine to perform any one or more of the methodologies discussed herein may be executed.

### DETAILED DESCRIPTION

Embodiments herein describe systems and methods for generating a digital wallet. A digital wallet permits transactions between two entities by exchanging digital currency for goods and services. Funds may be deposited into a digital wallet using a payment instrument (e.g., a credit card, cash). In some examples, a digital wallet may be linked to a user's bank account. The digital wallet is capable of storing any amount of value. The amount of value can correspond to currency or points that may be redeemed or exchanged for currency, goods, or services.

In some examples, an individual may initiate a transaction for a subscription service. The subscription service provides the user with a series of medical treatments over a period of time. The individual may use a digital wallet system to generate a digital wallet for payment of the subscription service. The individual may use their credit card to periodically deposit funds from their credit card (or any other payment instrument) to a wallet item within the digital wallet. The digital wallet system generates the wallet item and designates it for payment of the subscription service. An individual may have multiple wallet items within their digital wallet. Some wallet items may be designated for a specific use, and some may not have any specific designation.

Once an individual processes a transaction for their subscription service (e.g., when the individual receives a medical treatment from the subscription service), the digital wallet system transfers funds from the digital wallet to the subscription service provider. The funds may be transferred exclusively from one wallet item that is designated for payment of the subscription service, or a combination of wallet items. Once the funds from any particular wallet item are exhausted, the digital wallet system removes the wallet item from the digital wallet.

In some examples, an individual may wish to request a refund of one or more previously processed transactions. The digital wallet system validates the refund request based on a set of transaction rules that determine whether the individual qualifies for a refund and transfers funds back to the individual's digital wallet. For example, the digital wallet system may generate an additional wallet item that stores the refunded amount of value. Further details of the digital wallet system are described below.

The digital wallet system improves functionality of a computer system by efficiently storing and tracking transaction data. For example, a wallet item may be generated by the digital wallet system that is designated for a specific use. Wallet items may be deleted once funds associated with the wallet item are deleted. The digital wallet system is thus an improvement over traditional physical wallets because it allows a user to efficiently track and compartmentalize storage of transaction data associated with various subscription items without requiring multiple different physical payment instruments.

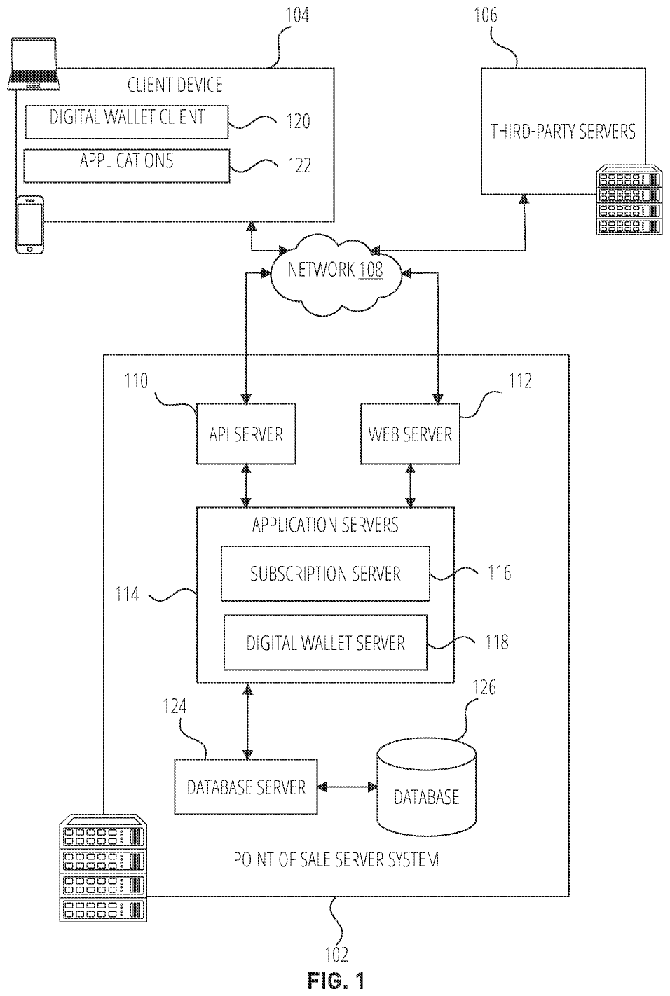

FIG. 1 is a block diagram showing an example point of sale system for conducting transactions over a network. The point-of-sale system includes multiple instances of a client device 104, each of which hosts a number of applications, including a digital wallet client 120 and other applications 122. Each digital wallet client 120 is communicatively coupled to other instances of the digital wallet client 120 (e.g., hosted on respective other client devices 104), a point-of-sale server system 102 and third-party servers 106 via a network 108 (e.g., the Internet). A digital wallet client 120 can also communicate with locally-hosted applications 122 using Applications Program Interfaces (APIs).

A digital wallet client 120 is able to communicate and exchange data with other digital wallet client 120 and with the point-of-sale server system 102 via the network 108. The data exchanged between digital wallet clients 120, and between a digital wallet client 120 and the point-of-sale server system 102, includes functions (e.g., commands to invoke functions) as well as payload data (e.g., sensitive data items, text, multimedia data, or transaction data).

The point-of-sale server system 102 provides server-side functionality via the network 108 to a particular digital wallet client 120. While certain functions of the point-of-sale system are described herein as being performed by either a digital wallet client 120 or by the point of sale server system 102, the location of certain functionality either within the digital wallet client 120 or the point of sale server system 102 may be a design choice. For example, it may be technically preferable to initially deploy certain technology and functionality within the point-of-sale server system 102 but to later migrate this technology and functionality to the digital wallet client 120 where a client device 104 has sufficient processing capacity.

The point-of-sale server system 102 supports various services and operations that are provided to the digital wallet client 120. Such operations include transmitting data to, receiving data from, and processing data generated by the digital wallet client 120. This data may include transaction data, user data, subscription data and provider data, as examples. Data exchanges within the point-of-sale server system 102 are invoked and controlled through functions available via user interfaces (UIs) of the digital wallet client 120.

Turning now specifically to the point-of-sale server system 102, an Application Program Interface (API) server 110 is coupled to, and provides a programmatic interface to, application servers 114. The application servers 114 are communicatively coupled to a database server 124, which facilitates access to a database 126 that stores data associated with the transactions processed by the application servers 114. Similarly, a web server 112 is coupled to the application servers 114 and provides web-based interfaces to the application servers 114. To this end, the web server 112 processes incoming network requests over the Hypertext Transfer Protocol (HTTP) and several other related protocols.

The API server 110 receives and transmits transaction data (e.g., commands and transaction data) between the client device 104 and the application servers 114. Specifically, the API server 110 provides a set of interfaces (e.g., routines and protocols) that can be called or queried by the digital wallet client 120 in order to invoke functionality of the application servers 114. The API server 110 exposes various functions supported by the application servers 114, including account registration, subscription creations and management, the processing of transactions, via the application servers 114, from a particular digital wallet client 120 to another digital wallet client 120.

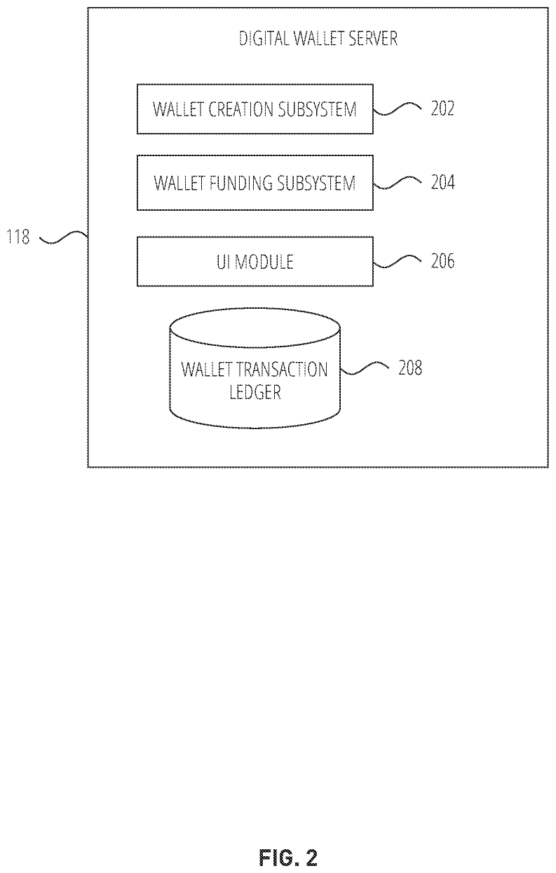

The application servers 114 host a number of server applications and subsystems, including for example a subscription server 116, and a digital wallet server 118. The subscription server 116 implements functionalities for creating and managing subscriptions between multiple client devices 104. The digital wallet server 118 provides functionalities for creating a digital wallet and managing funds associated with the digital wallet. Further details regarding the digital wallet server 118 are provided below in connection with FIG. 2.

FIG. 2 is a block diagram of a digital wallet server 118, according to some example embodiments. The digital wallet server 118 is shown to include a wallet creation subsystem 202, a wallet funding subsystem 204, a user interface (UI) module 206 and a wallet transaction ledger 208.

The wallet creation subsystem 202 facilitates the creation of a digital wallet. In some embodiments, the wallet creation subsystem 202 creates a digital wallet based on an indication received from the subscription server 116. The wallet creation subsystem 202 generates wallet items for inclusion into the digital wallet. The wallet items are associated with payment instruments for one or more goods or services.

The wallet funding subsystem 204 facilitates management of funds being deposited and removed from the digital wallet. The wallet funding subsystem 204 receives sensitive data from a client device 104. The sensitive data includes payment information (e.g., bank account numbers, credit card numbers, online payment account information, amount of value, etc.) associated with one or more goods or services purchased by a user. The wallet funding subsystem 204 associates the received sensitive data with one or more wallet items created by the wallet creation subsystem 202. The wallet funding subsystem 204 withdraws funds from the digital wallet in response to one or more requests from the point-of-sale server system 102. The requests may be in the form of an API request (e.g., by an API server 110), an HTTP request (via the network 108) or any suitable computer request protocol. The wallet funding subsystem 204 processes the requests by causing a transfer of funds from the digital wallet to an external entity (e.g., a third-party bank account located at one or more third-party servers 106).

The wallet funding subsystem 204 stores information about the funds being deposited and removed from the digital wallet into a database 126. In some examples, the database 126 is a wallet transaction ledger 208. The wallet transaction ledger 208 monitors the creation and removal of wallet items from the digital wallet. The wallet transaction ledger 208 further monitors the designation associated with each wallet item and an associated subscription service.

A user may access and manage a digital wallet using a UI Module 206. The UI Module 206 causes presentation of a virtual representation of the digital wallet on a client device 104. The UI Module 206 further includes selectable user interface elements (e.g., buttons, check boxes, scrollbar, text boxes, etc.) that are used to create a digital wallet, create a wallet item, add funds to the digital wallet, and remove funds from the digital wallet.

Although the described flow diagram below can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

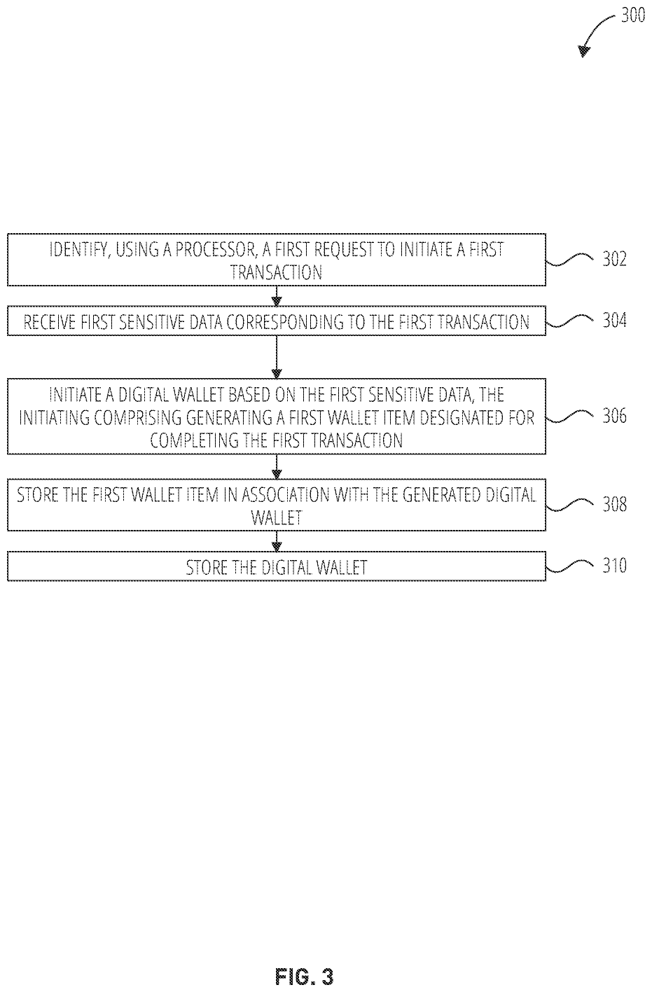

FIG. 3 is a method 300 for generating a digital wallet, according to example embodiments. In one example, the processor in a digital wallet server 118, the processor in the client device 104, the processor in the point-of-sale server system 102 or any combination thereof, can perform the operations in the method 300.

At operation 302, the digital wallet server 118 identifies, using a processor, a first request to initiate a first transaction. The first request may be an API request (by the API server 110), an HTTP request (via the network 108), or any other suitable computer request protocol. In some examples, the first request may be a combination of an API request and an HTTP request. The first transaction is a transaction for a good or service. The first transaction may be associated with a subscription item generated by the subscription server 116.

At operation 304, the digital wallet server 118 receives first sensitive data corresponding to the first transaction. The first sensitive data includes information regarding a payment corresponding to the first transaction. The first sensitive data may include a payment instrument (e.g., credit card transaction data), an amount of value associated with the first transaction and user data associated with the first transaction. The amount of value can correspond to currency or points that may be redeemed or exchanged for currency, goods, or services.

At operation 306, the digital wallet server 118 initiates a digital wallet based on the first sensitive data. The digital wallet server 118 initiates the digital wallet by generating a first wallet item. The first wallet item is designated for completing the first transaction. In some examples, the first wallet item may be designated to complete transactions including but not limited to the first transaction.

The first wallet item includes an amount of value received by the one or more payment instruments. In some examples the digital wallet server 118 transfers the amount of value received by the one or more payment instruments from a first account linked to the first sensitive data to the digital wallet. The digital wallet server 118 stores the amount of value in association with the first wallet item.

At operation 308, the digital wallet server 118 stores the first wallet item in association with the generated digital wallet. At operation 310, the digital wallet server 118 stores the digital wallet.

In some examples, the digital wallet includes multiple wallet items. For example, the digital wallet server 118 may receive second sensitive data corresponding to a second transaction. The digital wallet server 118 generates a second wallet item designated for completing the second transaction and stores the second wallet item in association with the digital wallet.

The digital wallet server 118 further causes display of a graphical user interface (GUI) on a client device (e.g., client device 104). The, GUI includes a first portion and a second portion. The first portion comprises a visual representation of the digital wallet, and the second portion comprises first transaction data associated with the first transaction.

The digital wallet server 118 may receive input indicative of a selection of a first selectable user interface element. The first selectable user interface element may be associated with the first wallet item. In response to receiving the input, the digital wallet server 118 modifies the graphical user interface by updating the first transaction data and updating the visual representation of the digital wallet.

In some examples, the digital wallet server 118 updates the first transaction data by generating an updated transaction value. The first transaction data may include a total value (e.g., a cost of a good or service associated with the first transaction). The digital wallet server 118 generates an updated transaction value based on subtracting the amount of value associated with the first wallet item from a total value associated with the first transaction data. The digital wallet server 118 causes display of the updated transaction value within the second portion of the graphical user interface.

In some examples, the digital wallet server 118 updates the visual representation of the digital wallet by deleting the first wallet item from the digital wallet. For example, the display of the virtual representation of the digital wallet includes a visual representation of the first wallet item. After all of the funds from the first wallet item has been applied to the first transaction, the digital wallet server 118 deletes the first wallet item from the digital wallet and removes display of the virtual representation of the first wallet item from the first portion of the GUI.

The digital wallet server 118 receives a second request (e.g., API request, HTTP request, etc.) to process the first transaction and in response to receiving the second request, processes the first transaction. In some examples, receiving the second request causes the digital wallet server 118 to transfer the amount of value from the digital wallet to a third account linked with a third entity.

In some examples, the digital wallet server 118 processes refunds for previously made transactions. The digital wallet server 118 may receive the refund request (e.g., a third request) as a request to modify the processed transaction (e.g., the first transaction). In respond to receiving the refund request, the digital wallet server 118 validates the refund request based on a set of transaction rules associated with the previously made transaction. The set of transaction rules may be based on one or more of user data associated with the transaction, the sensitive data associated with the transaction and the type of good or service associated with the transaction. In response to validating the refund request, the digital wallet server 118 determines modified transaction data. The modified transaction data includes a second amount of value associated with the refund. The second amount of value may be the same amount of value as the previously made transaction or it may be a different amount of value. The digital wallet server 118 transfers the second amount of value based on the modified transaction data from the third account to the digital wallet.

After processing the refund, the digital wallet server 118 generates a third wallet item based on the second amount of value and stores the third wallet item in association with the digital wallet. For example, instead of processing a refund to the original payment instrument, the digital wallet server 118 may process a refund and return funds to the digital wallet directly.

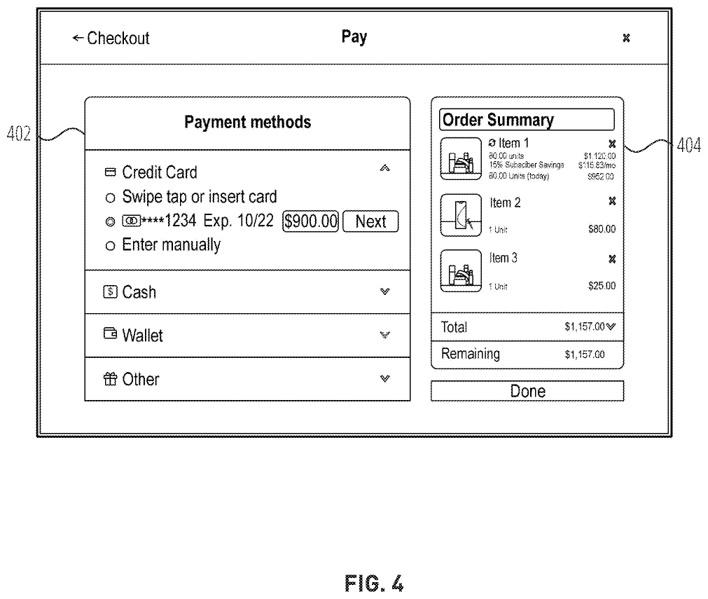

FIG. 4 is an illustration of a graphical user interface presented by the digital wallet server 118. The graphical user interface is shown to include two portions: portion 402 includes a visual representation of the digital wallet and portion 404 includes transaction data associated with a transaction.

Once a user initiates a process to complete a transaction, the digital wallet server 118 causes presentation of the GUI shown in FIG. 4. The user may select one or more payment methods from portion 402 to complete their transaction. One option of a payment method for a given transaction is using funds from a digital wallet.

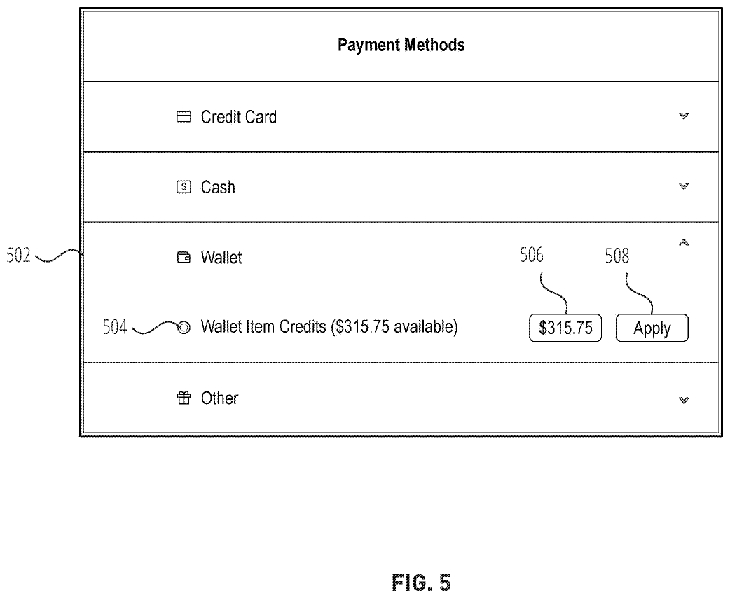

FIG. 5 is an illustration of a graphical user interface presented by the digital wallet server 118. Each of the payment methods shown within the portion 402 of the GUI may be represented by selectable user interface elements (e.g., buttons, checkboxes, toggles, etc.). A user may select the selectable user interface element 502 that represents the digital wallet. Upon receiving an input indicative of the selection, the digital wallet server 118 causes presentation of the wallet items within the digital wallet. A user may select the selectable user interface element 504 that represents the wallet item funds that the user wants to apply to the transaction. In some examples the user may configure the amount of wallet item funds to be applied to the transaction by manually entering the amount in user interface element 506. After the user finalizes the amount of wallet item funds to be applied to the transaction, the user may select user interface element 508 to apply the wallet item funds to the transaction.

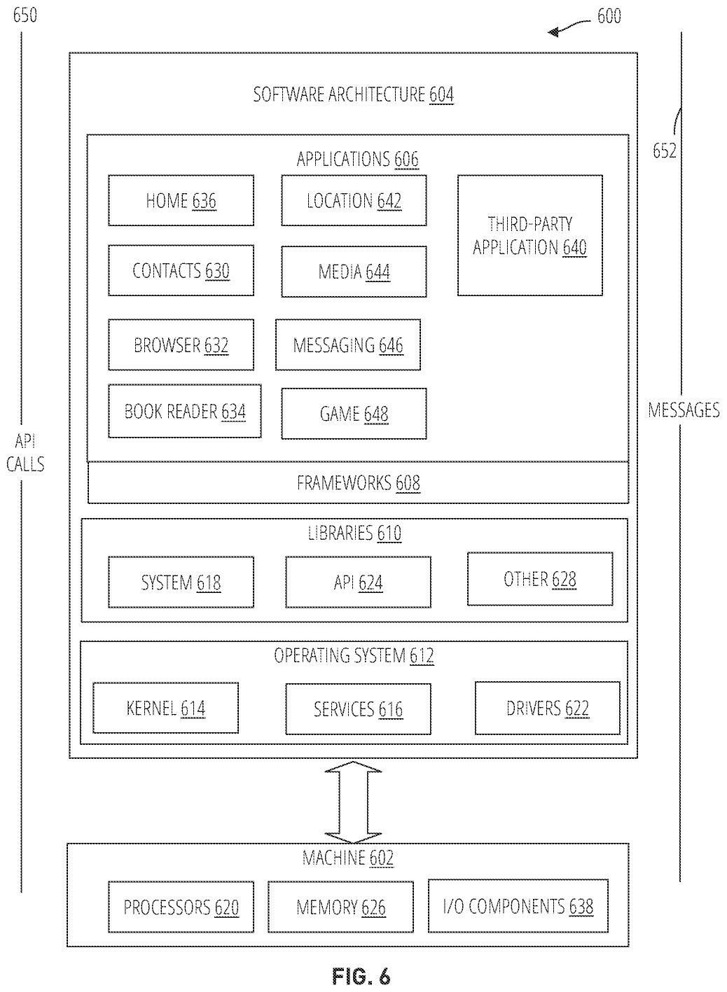

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 610 provide a low-level common infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a high-level common infrastructure that is used by the applications 606. For example, the frameworks 608 provide various graphical user interface (deleted) (GUI) functions, high-level resource management, and high-level location (deleted) services. The frameworks 608 can provide a broad spectrum of other APIs that can be used by the applications 606, some of which may be specific to a particular operating system or platform.

In an example embodiment, the applications 606 may include a home application 636, a contacts application 630, a browser application 632, a book reader application 634, a location application 642, a media application 644, a messaging application 646, a game application 648, and a broad assortment of other applications such as a third-party application 640. The e applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

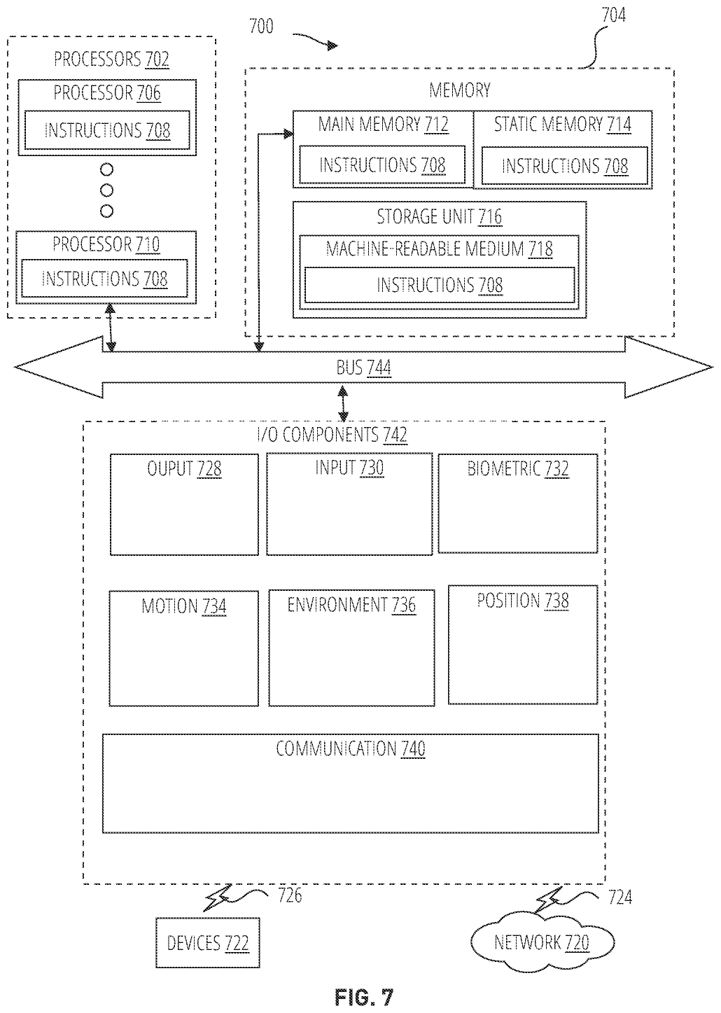

FIG. 7 is a diagrammatic representation of the machine 700 within which instructions 708 (e.g., software, a program, an application, an applet, an app, or other executable code) for causing the machine 700 to perform any one or more of the methodologies discussed herein may be executed. For example, the instructions 708 may cause the machine 700 to execute any one or more of the methods described herein. The instructions 708 transform the general, non-programmed machine 700 into a particular machine 700 programmed to carry out the described and illustrated functions in the manner described.

The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is illustrated, the term “machine” shall also be taken to include a collection of machines that individually or jointly execute the instructions 708 to perform any one or more of the methodologies discussed herein.

The machine 700 may include processors 702, memory 704, and I/O components 742, which may be configured to communicate with each other via a bus 744. In an example embodiment, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 706 and a processor 710 that execute the instructions 708. The term “processor” is intended to include multi-core processors that may comprise two or more independent processors (sometimes referred to as “cores”) that may execute instructions contemporaneously. Although FIG. 7 shows multiple processors 702, the machine 700 may include a single processor with a single core, a single processor with multiple cores (e.g., a multi-core processor), multiple processors with a single core, multiple processors with multiples cores, or any combination thereof.

The memory 704 includes a main memory 712, a static memory 714, and a storage unit 716, both accessible to the processors 702 via the bus 744. The main memory 704, the static memory 714, and storage unit 716 store the instructions 708 embodying any one or more of the methodologies or functions described herein. The instructions 708 may also reside, completely or partially, within the main memory 712, within the static memory 714, within machine-readable medium 718 within the storage unit 716, within at least one of the processors 702 (e.g., within the processor's cache memory), or any suitable combination thereof, during execution thereof by the machine 700.

The I/O components 742 may include a wide variety of components to receive input, provide output, produce output, transmit information, exchange information, capture measurements, and so on. The specific I/O components 742 that are included in a particular machine will depend on the type of machine. For example, portable machines such as mobile phones may include a touch input device or other such input mechanisms, while a headless server machine will likely not include such a touch input device. It will be appreciated that the I/O components 742 may include many other components that are not shown in FIG. 7. In various example embodiments, the I/O components 742 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location (deleted) and/or force of touches or touch gestures, or other tactile input components), audio input components (e.g., a microphone), and the like.

In further example embodiments, the I/O components 742 may include biometric components 732, motion components 734, environmental components 736, or position components 738, among a wide array of other components. For example, the biometric components 732 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 include acceleration sensor components (e.g., accelerometer), gravitation sensor components, rotation sensor components (e.g., gyroscope), and so forth. The environmental components 736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 include location (deleted) sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 742 further include communication components 740 operable to couple the machine 700 to a network 720 or devices 722 via a coupling 724 and a coupling 726, respectively. For example, the communication components 740 may include a network interface component or another suitable device to interface with the network 720. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 722 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location (deleted) via Internet Protocol (IP) geolocation, location (deleted) via Wi-Fi® signal triangulation, location (deleted) via detecting an NFC beacon signal that may indicate a particular location (deleted), and so forth.

The various memories (e.g., memory 704, main memory 712, static memory 714, and/or memory of the processors 702) and/or storage unit 716 may store one or more sets of instructions and data structures (e.g., software) embodying or used by any one or more of the methodologies or functions described herein. These instructions (e.g., the instructions 708), when executed by processors 702, cause various operations to implement the disclosed embodiments.

The instructions 708 may be transmitted or received over the network 720, using a transmission medium, via a network interface device (e.g., a network interface component included in the communication components 740) and using any one of a number of well-known transfer protocols (e.g., hypertext transfer protocol (HTTP)). Similarly, the instructions 708 may be transmitted or received using a transmission medium via the coupling 726 (e.g., a peer-to-peer coupling) to the devices 722.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
identifying, using a processor, a first request to initiate a first transaction;
receiving first sensitive data corresponding to the first transaction;
initiating a digital wallet based on the first sensitive data, the initiating comprising generating a first wallet item designated for completing the first transaction;
storing the first wallet item in association with the generated digital wallet; and
storing the digital wallet.

2. The method of claim 1, further comprising:
transferring an amount of value from a first account linked to the first sensitive data to the digital wallet; and
storing the amount of value in association with the first wallet item.

3. The method of claim 1, further comprising:
receiving second sensitive data corresponding to a second transaction;
generating a second wallet item designated for completing the second transaction; and
storing the second wallet item in association with the digital wallet.

4. The method of claim 2, further comprising:
causing display of a graphical user interface on a client device, the graphical user interface comprising a first portion and a second portion, wherein the first portion comprises a visual representation of the digital wallet, and the second portion comprises first transaction data associated with the first transaction;
receiving input indicative of a selection of a first selectable user interface element, the first selectable user interface element associated with the first wallet item;
in response to receiving the input, modifying the graphical user interface, the modification comprising updating the first transaction data and updating the visual representation of the digital wallet;
receiving a second request to process the first transaction; and
in response to receiving the second request, processing the first transaction.

5. The method of claim 4, wherein updating the first transaction data further comprises:
generating an updated transaction value, the updated transaction value generated based on subtracting the amount of value associated with the first wallet item from a total value associated with the first transaction data; and
causing display of the updated transaction value within the second portion of the graphical user interface.

6. The method of claim 4, wherein:
the display of the visual representation of the digital wallet comprises a visual representation of the first wallet item,
the updating the digital wallet further comprising:
deleting the first wallet item from the digital wallet; and
removing display of the visual representation of the first wallet item from the first portion of the graphical user interface.

7. The method of claim 4, wherein receiving the request to process the first transaction further comprises:
transferring the amount of value from the digital wallet to a third account linked with a third entity.

8. The method of claim 7, wherein:
the amount of value is a first amount of value,
the method further comprising:
receiving a third request to modify the processed first transaction;
validating the third request based on a set of transaction rules associated with the first transaction;
in response to validating the third request, determining modified first transaction data; and
transferring a second amount of value based on the modified transaction data from the third account to the digital wallet.

9. The method of claim 8, further comprising:
generating a third wallet item based on the second amount of value; and
storing the third wallet item in association with the digital wallet.

10. A system comprising:
a processor; and
a memory storing instructions that, when executed by the processor, configure the system to:
identify a first request to initiate a first transaction;
receive first sensitive data corresponding to the first transaction;
initiate a digital wallet based on the first sensitive data, the initiating comprising generating a first wallet item designated for completing the first transaction;
store the first wallet item in association with the generated digital wallet; and
store the digital wallet.

11. The system of claim 10, wherein the instructions further configure the system to:
transfer an amount of value from a first account linked to the first sensitive data to the digital wallet; and
store the amount of value in association with the first wallet item.

12. The system of claim 10, wherein the instructions further configure the system to:
receive second sensitive data corresponding to a second transaction;
generate a second wallet item designated for completing the second transaction; and
store the second wallet item in association with the digital wallet.

13. The system of claim 11, wherein the instructions further configure the system to:
cause display of a graphical user interface on a client device, the graphical user interface comprising a first portion and a second portion, wherein the first portion comprises a visual representation of the digital wallet, and the second portion comprises first transaction data associated with the first transaction;
receive input indicative of a selection of a first selectable user interface element, the first selectable user interface element associated with the first wallet item;
in response to receiving the input, modify the graphical user interface, the modification comprising updating the first transaction data and updating the visual representation of the digital wallet;
receive a second request to process the first transaction; and
in response to receiving the second request, process the first transaction.

14. The system of claim 13, wherein updating the first transaction data further configure the system to:
generate an updated transaction value, the updated transaction value generated based on subtracting the amount of value associated with the first wallet item from a total value associated with the first transaction data; and
cause display of the updated transaction value within the second portion of the graphical user interface.

15. The system of claim 13, wherein:
the display of the visual representation of the digital wallet comprises a visual representation of the first wallet item,
the updating the digital wallet further configures the system to:
delete the first wallet item from the digital wallet; and
remove display of the visual representation of the first wallet item from the first portion of the graphical user interface.

16. The system of claim 13, wherein receiving the request to process the first transaction further configures the system to:
transfer the amount of value from the digital wallet to a third account linked with a third entity.

17. The system of claim 16, wherein:
the amount of value is a first amount of value,
the system further configured to:
receive a third request to modify the processed first transaction;
validate the third request based on a set of transaction rules associated with the first transaction;
in response to validating the third request, determine modified first transaction data; and
transfer a second amount of value based on the modified transaction data from the third account to the digital wallet.

18. The system of claim 17, wherein the instructions further configure the system to:
generate a third wallet item based on the second amount of value; and
store the third wallet item in association with the digital wallet.

19. A non-transitory computer-readable storage medium, the computer-readable storage medium including instructions that when executed by a computer, cause the computer to:
identify a first request to initiate a first transaction;
receive first sensitive data corresponding to the first transaction;
initiate a digital wallet based on the first sensitive data, the initiating comprising generating a first wallet item designated for completing the first transaction;
store the first wallet item in association with the generated digital wallet; and
store the digital wallet.

20. The computer-readable storage medium of claim 19, wherein the instructions further configure the computer to:
transfer an amount of value from a first account linked to the first sensitive data to the digital wallet; and
store the amount of value in association with the first wallet item.
